(19) United States
(12) Patent Application Publication
(10) Pub. No.: US 2018/0304296 A1
(43) Pub. Date: Oct. 25, 2018

(54) SMART CARTRIDGE FOR DISPENSING A FLUID

(71) Applicant: NOSO, Inc., Lewes, DE (US)

(72) Inventors: VLADYSLAV TKACHENKO, Kyiv (UA); Andrii Kuzmin, Kyiv (UA)

(21) Appl. No.: 15/956,869

(22) Filed: Apr. 19, 2018

Related U.S. Application Data
(60) Provisional application No. 62/487,950, filed on Apr. 20, 2017.

(51) Int. Cl. B05B 17/06; B05B 17/00; B05B 1/30

(52) U.S. Cl. CPC B05B 17/0676; B05B 12/08; B05B 1/3006; B05B 17/0646

(57) ABSTRACT

Disclosed is a system for dispensing a fluid. The system may include a cartridge and a main unit configured to be coupled to the cartridge. The cartridge may comprise a container which may include at least one opening and at least one membrane in fluid communication with the at least one opening. Further, the cartridge may include at least one actuator which, upon activation, may be configured to cause the fluid to pass through the at least one membrane. Furthermore, the cartridge may include at least one storage device configured to store fluid data representing at least one characteristic associated with the fluid. Additionally, the cartridge may be operably associated with at least one controller configured to control activation of the at least one actuator based on the fluid data. The controller may be configured within the cartridge or be coupled to the cartridge by way of, for example, a main unit.

### RELATED APPLICATION

Under provisions of 35 U.S.C. § 119(e), the Applicant claims the benefit of U.S. provisional application No. 62/487,950, filed on Apr. 20, 2017, in the name of the same inventors and Applicant, which is incorporated herein by reference.

### FIELD OF DISCLOSURE

The present disclosure generally relates to fluid dispensing. More specifically, the present disclosure relates to a smart cartridge for dispensing a fluid.

### BACKGROUND

There are several applications where controlled dispensing of fluids is required. For instance, due to their potency, certain substances, such as essential oils, fragrant oils, medicinal oils, etc. are to be dispensed in an accurately controller manner. Accordingly, currently various mechanisms of enabling a moderated flow of such fluids are provided. For example, cartridges for dispensing essential oils commonly use piezoelectric membranes to control flow of the fluids contained in a bottle. Activation of the piezoelectric membranes results in ejection of the fluid in the form of a spray. However, such cartridges require a transport mechanism such as a tube for transporting the fluid from the bottle towards one side of the piezoelectric membrane. Further, the use of the transport mechanism may reduce a quality and/or accuracy of the dispensing.

Accordingly, there is need for improved apparatus for dispensing of fluids. In particular, there is a need for an improved cartridge design for accurately dispensing fluids.

### BRIEF OVERVIEW

A cartridge for dispensing a fluid may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed is a system for dispensing a fluid. The system may include a cartridge and a main unit configured to be coupled to the cartridge. The cartridge may comprise a container which may include at least one opening and at least one membrane in fluid communication with the at least one opening. Further, the cartridge may include at least one actuator which, upon activation, may be configured to cause the fluid to pass through the at least one membrane. Furthermore, the cartridge may include at least one storage device configured to store fluid data representing at least one characteristic associated with the fluid. Additionally, the cartridge may be operably associated with at least one controller configured to control activation of the at least one actuator based on the fluid data. The controller may be configured within the cartridge or be coupled to the cartridge by way of, for example, a main unit.

Further disclosed is a cartridge for dispensing a fluid. Accordingly, the cartridge may include a container configured to contain the fluid. Further, the container may include at least one opening. Additionally, the cartridge may include at least one membrane configured to be in fluid communication with the at least one opening. Further, the at least one membrane may be permeable to the fluid. Further, the cartridge may include at least one actuator coupled to the at least one membrane. Furthermore, the at least one actuator, upon activation, may be configured to cause the fluid to pass through the at least one membrane. Moreover, the cartridge may include at least one storage device configured to store fluid data representing at least one characteristic associated with the fluid. Additionally, the cartridge may include at least one controller electrically coupled to each of the at least one actuator and the at least one storage device. Further, the at least one controller may be configured to control activation of the at least one actuator based on the fluid data. The at least one controller, therefore, may be directly or indirectly coupled to a power source used for the transmission of an actuation signal. The power source may be supplied from a main unit. In some embodiments, the power source may be, for example, a battery residing within the cartridge.

Also disclosed is a cap configured for use with a container of fluid for facilitating dispensing of the fluid. Accordingly, the cap may include a first opening configured to be coupled with a mouth of a container. Further, the cap may include a second opening configured to facilitate dispensing of the fluid. Additionally, the cap may include a channel configured to fluidly connect the first opening to the second opening. Further, the cap may include a membrane covering the second opening. Furthermore, the membrane may be permeable to the fluid. Additionally, the cap may include an actuator coupled to the membrane. Further, the actuator, upon activation, may be configured to cause the fluid to pass through the membrane. Furthermore, the cap may include a storage device configured to store fluid data representing at least one characteristic associated with the fluid. Additionally, the cap may include a controller electrically coupled to each of the actuator and the storage device. Further, the controller may be configured to control activation of the actuator based on the fluid data.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a cartridge configured to dispense a fluid, consistent with the present disclosure.

FIG. 2A, 2B, 2C, 2D, 2E illustrates closer view of a cap of the cartridge depicting flow of air and fluid, in accordance with some embodiments.

FIG. 3 illustrates a cut away view of the cap of the cartridge along with the piezoelectric spraying membrane, in accordance with some embodiments.

FIG. 4A, 4B illustrates a cap configured to be used with a container for dispensing fluid from the container, in accordance with some embodiments.

FIG. 5 illustrates a flowchart of a method of dispensing a fluid based on at least one characteristic of the fluid, in accordance with some embodiments.

FIG. 6 illustrates a main unit configured to secure multiple cartridges, consistent with the present disclosure.

FIG. 7 illustrates a block diagram of a computing system, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of dispensing fluids, embodiments of the present disclosure are not limited to use only in this context. For example, the principles and techniques disclosed herein may be understood to be applicable for adaptively dispensing other kinds of substances based on associated characteristics.

I. Cartridge Overview

Consistent with embodiments of the present disclosure, a cartridge for dispensing a fluid (also referred to herein as “cartridge”) may be provided. This overview is provided to introduce a selection of concepts in a simplified form that are further described below. This overview is not intended to identify key features or essential features of the claimed subject matter. Nor is this overview intended to be used to limit the claimed subject matter's scope. The cartridge may be used by individuals and/or robots for accurately dispensing controlled quantities of fluid.

The present disclosure generally relates to a cartridge for dispensing liquids (e.g. essential oils) using a piezoelectric membrane treated to exhibit oleophobic/hydrophobic properties.

More specifically, the cartridge may be configured to dispense liquids by inverting the cartridge and allowing the liquid to reach the membrane through action of gravity. Further, oleophobic treatment applied to the membrane may prevent the liquid from wetting the membrane or going through the membranes pores, unless electricity is applied.

In addition, a microchip connected to the membrane may control the operation of the membrane. This enables a diffusion device to read the cartridge and understand how to dispense the liquid in that cartridge. This enables a single diffuser to work with multiple cartridges.

II. Cartridge Configuration

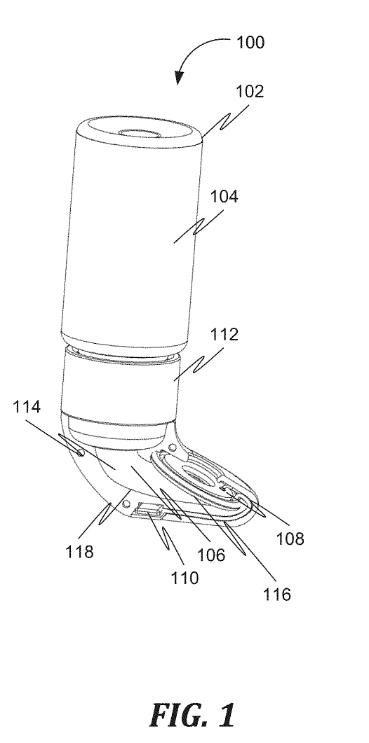

FIG. 1 is an illustration of a cartridge 100 consistent with various embodiments of the present disclosure. The cartridge 100 may include a container 102 containing a fluid 104. The fluid 104 may be a standard essential oil. The container 102 may include at least one opening 106. The cartridge 100 may also include at least one membrane 108 configured to be in fluid communication with the at least one opening 106, wherein the at least one membrane 108 is permeable to the fluid 104.

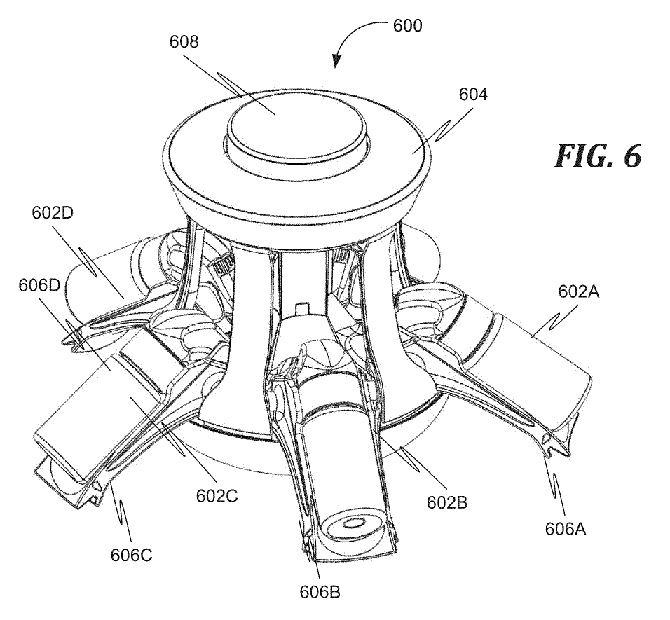

Accordingly, in some embodiments, in order to eliminate the tube in conventional cartridges, the cartridge 100 may be inverted to enable gravity to feed the fluid 104 to the at least one membrane 108. Further, the cartridge 100 may be coupled to at least one actuator. As will be detailed below, the actuator may be embedded in a main unit and coupled to the at least one membrane 108 via a contact point between cartridge 100 and the main unit. As will be detailed with reference to FIG. 6, coupling may occur via placement of cartridge into a main unit at a contact point comprising, for example, a PCB contact plate. It should be understood that an actuator may be comprised of multiple elements as disclosed below. For example, in various embodiments, the actuator may be comprised of a controller and an amplifier embedded within, for example, but not limited to, a main unit. The actuator may further be coupled to a power source for providing a signal. In other embodiments, the actuator may be integrated into cartridge 100.

At least one or all components of the at least one actuator, upon activation, may be configured to transmit a signal to cartridge 100 to the at least one membrane 108, which in turn may cause the fluid 104 to pass through the at least one membrane 108. When alternating current is applied to the at least one membrane 108, the vibration causes flow of the fluid 104.

Upon actuation, the at least one membrane 108 may come in contact with the fluid 104 and become saturated with the fluid 104. Further, the saturation may cause leakage. Moreover, the saturation may prevent the at least one membrane 108 from functioning when electricity is applied, because the at least one membrane 108 may be blocked from the air at the external surface of the at least one membrane 108, and therefore cannot push air into the cartridge 100.

Accordingly, an improvement in the at least one membrane 108 is provided to facilitate use of the cartridge 100 in an inverted orientation. In some embodiments, at least a portion of the at least one membrane 108 may exhibit oleophobic properties. For example, an oleophobic treatment may be applied to the at least one membrane 108. The olephobic treatment doesn't allow the fluid 104 to saturate the metal of the at least one membrane 108. As a result, the fluid 104 may be prevented from going through the pores of the at least one membrane 108, unless electricity is applied.

Further, the cartridge 100 may include at least one storage device configured to store fluid data representing at least one characteristic associated with the fluid 104 and at least one controller electrically coupled to each of the at least one actuator and the at least one storage device, wherein the at least one controller is configured to control activation of the at least one actuator based on the fluid data. For example, the storage device and the at least one controller may be included on a chip 110. In some embodiments, in which the chip comprises controller, chip 110 may be connected to the at least one membrane 108 to control operation of the at least one membrane 108. In various embodiments, however, the chip may simple comprise data for operating an actuator which, in turn, controls the operation of the at least one membrane 108.

Furthermore, the chip 110 may comprise various data associated with the cartridge 100. For instance, the chip 110 may include an identifier (ID) of the cartridge 100 and operating parameters of the cartridge 100 in relation to spraying. The parameters may include, for example, but not be limited to, voltage and current requirements corresponding to a type of the fluid stored in the cartridge 100. Said requirements may ensure the proper actuation of the mechanical and electronic components of cartridge 100 in order to affect proper fluid dispersion. The chip 110 may include different parameters corresponding to different kinds of fluids and oils to be dispensed by the cartridge 100. Further, the cartridge 100 may be operated by alternating current and an amplitude of the alternating current may control spraying properties such as, for example, a quantity and speed of the fluid dispensed. As will be detailed below, chip 110 may comprise outputs to a contact point, which interfaces chip 110 with a controller of, for example, a main unit. The controller may be configured to read the data from chip 110 and, in accordance to the operational parameters of chip 110, cause an operation of an actuator.

In some embodiments, the cartridge 100 may include a cap 112 configured to be attachable to the container 102. The cap 112 may include a first opening 114, a second opening 116 and a channel 118 configured to provide a fluid communication between the first opening 114 and the second opening 116. The first opening 114 may be fluidly coupled to the at least one opening 106 of the container 102. The second opening 116 may be covered by the at least one membrane 108, wherein each of the at least one actuator, the at least one storage device and the at least one controller may be comprised in the cap 112.

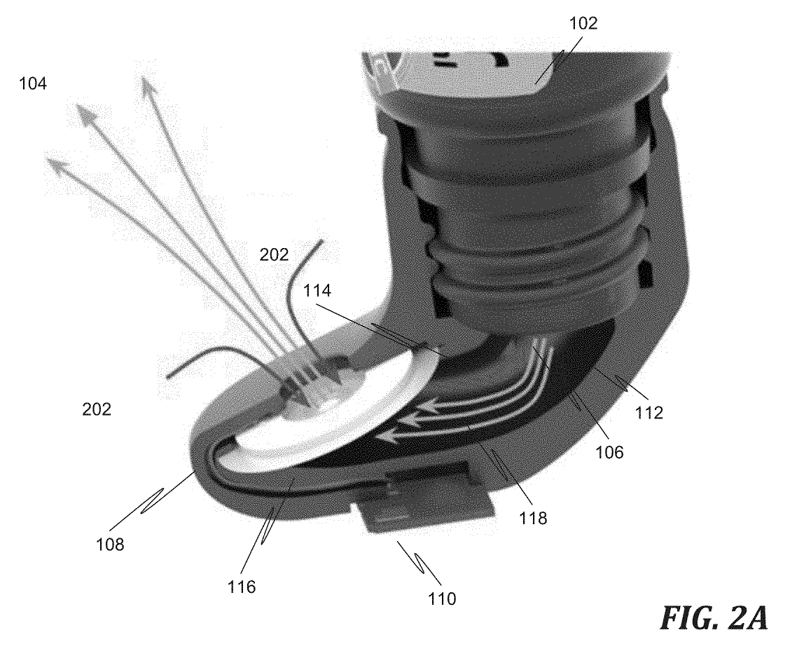

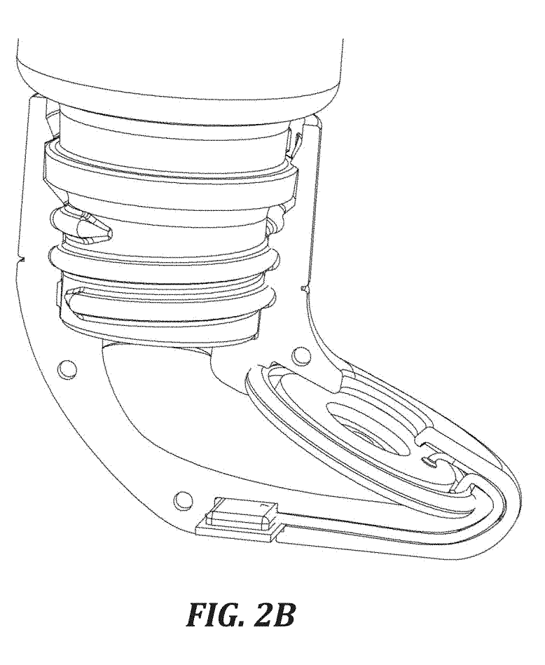

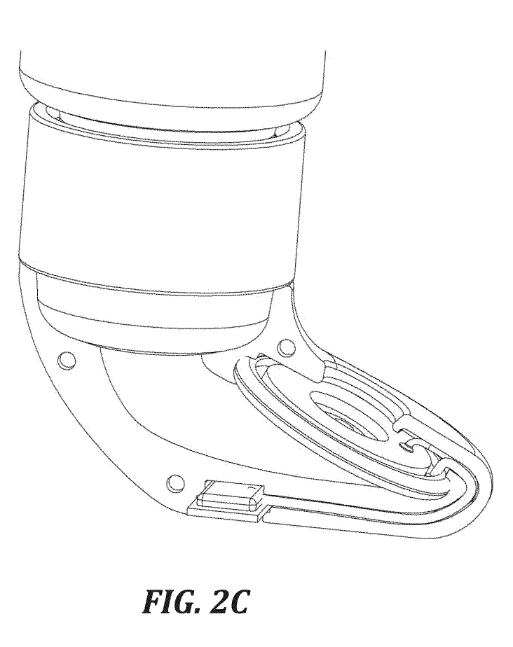

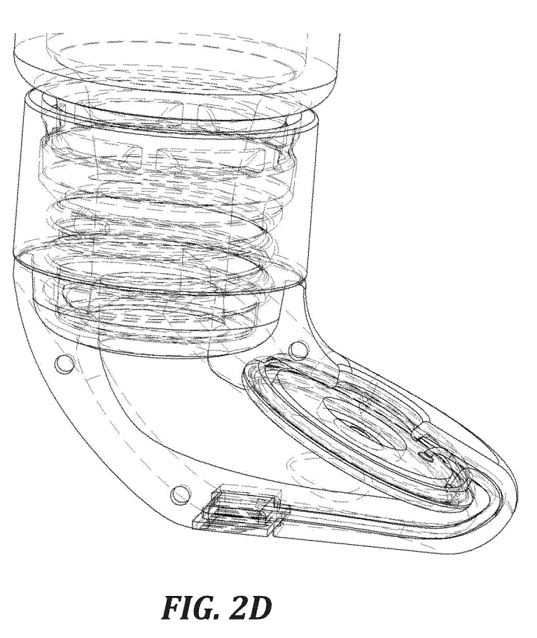

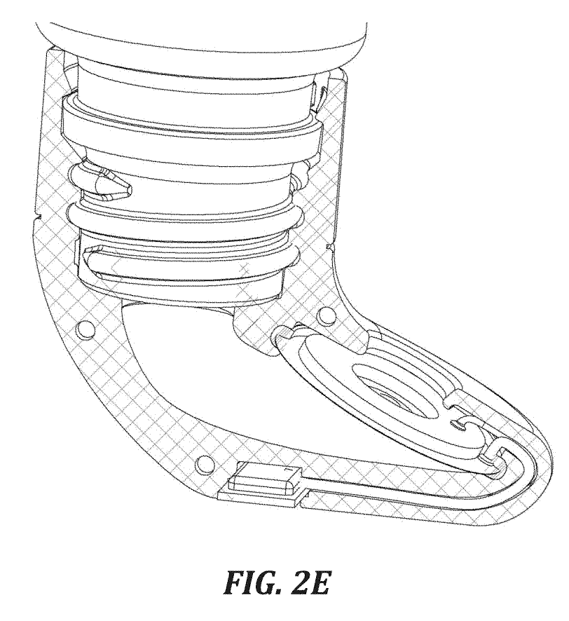

FIG. 2A, 2B, 2C, 2D, 2E illustrates a closer view of the cap 112 of the cartridge 100 depicting flow of air 202 (path shown by red arrows) and the fluid 104 (path shown by orange arrows), in accordance with some embodiments. The at least one actuator may be configured to cause the air 202 to flow in through the at least one membrane 108 and into the at least one opening 106 of the container 102, wherein the at least one actuator may be further configured to cause the fluid 104 to flow out through the at least one membrane 108. Actuation may cause the at least one membrane 108 to dispense the fluid through its otherwise treated membrane.

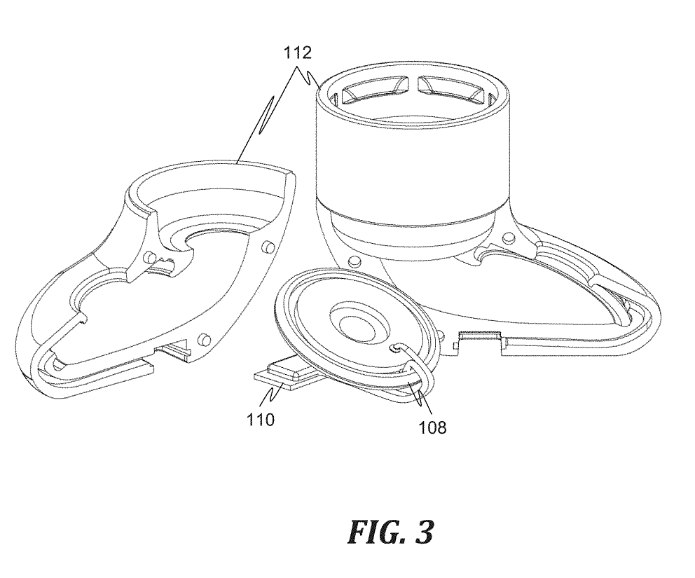

FIG. 3 illustrates a cut away view of the cap 112 of the cartridge 100 along with the at least one membrane 108, in accordance with some embodiments. In some embodiments, the at least one membrane 108 may be a piezoelectric spraying membrane 108. The piezoelectric spraying membrane 108 may include a plurality of micropores, wherein the at least one actuator may be configured to create a pressure differential between an inside of the piezoelectric spraying membrane 108 and an outside of the piezoelectric spraying membrane 108, wherein the pressure differential causes ejection of the fluid 104 through the piezoelectric spraying membrane 108 facilitating dispensing of the fluid 104 from the cartridge 100.

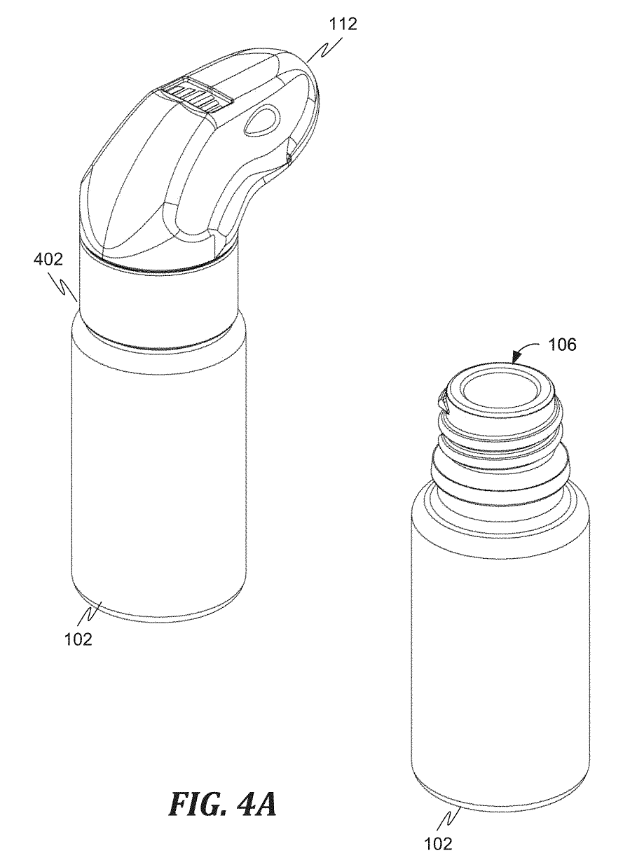

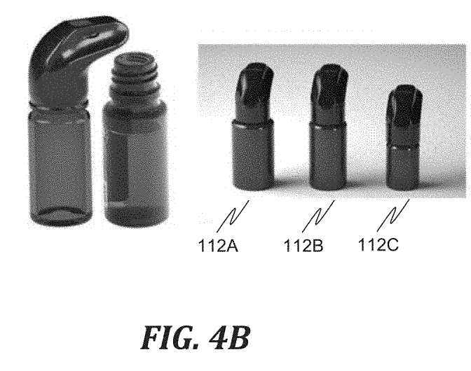

FIG. 4A, 4B illustrates the cap 112 configured to be used with the container 102 for dispensing the fluid 104 from the container 102, in accordance with some embodiments. The container 102 may include a standard DIN18 bottle head. Further, the cap 112 may be designed to be attached to the DIN18 bottle head of the container 102. This simplifies distribution, lowers costs and removes the barriers of manufacturing by third parties. The cap 112 may be designed to be attached to various sized containers. For example, a cap 112A may be attached to a 15 ml container. A cap 112B may be attached to a 10 ml container. A cap 112C may be attached to a 5 ml container.

Further, the cap 112 may include a blocking ring 402 configured to prevent the cap 112 from being removed once screwed onto the container 102. The cap 112 may also include a contact plate 404 of the embedded electronic chip 110. Chip 110 may be configured to come into contact, either directly or indirectly, with a main unit configured to provide an electrical signal to actuate the cartridge 100.

In some embodiments, the cartridge 100 may be configured to receive instructions from the main unit and provide the electrical signal upon receipt of the instructions. The instructions may cause supply of an electrical signal sourced from, for example, a battery or power source to the at least one actuator in the cartridge 100.

FIG. 6 illustrates a main unit 600 configured to secure multiple cartridges 602A-D, consistent with the present disclosure. The main unit 600 may be used to safely store the multiple cartridges 602A-D. Each storage point may comprise a contact point for electronically coupling each cartridge to the main unit 600.

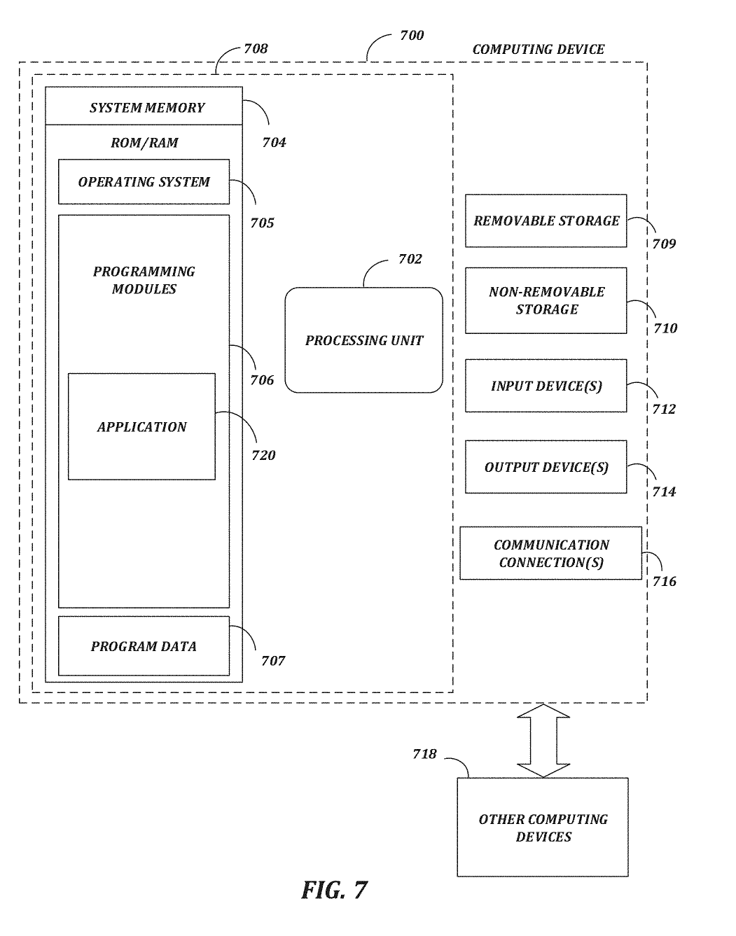

The main unit 600 may include a central unit 604. In some embodiments, central unit 604 may be configured to house, by way of non-limiting example, a controller, an amplifier, and a power supply. In some embodiments, the controller may be operatively associated with a computing device 700 as detailed with reference to FIG. 7. Collectively, or in various combinations, such components may be referred to as an ‘actuator’ in the present disclosure and claims. Further, multiple tabs 606A-D may be rotatably connected to the central unit 604. The multiple cartridges 602A-D may be secured to the multiple tabs 606A-D respectively. FIG. 6 shows the multiple tabs 606A-D in an open position. In the open position, a user may quickly replace a cartridge from the corresponding tab to use the cartridge. The multiple tabs 606A-D may rotate towards the central unit 604 to safely store the multiple cartridges 602A-D in a closed position. The user may use a button 608 on the central unit 604 to open or close the multiple tabs 606A-D.

Each cartridge may come into electric contact with main unit 600 via, for example, a contact point. The contact point may be comprised of, for example, a PCB contact plate. In some embodiments, the contact plate may be comprised of six connection points. A portion of the connection points may be coupled to chip 110 while another portion of the connection points may be coupled to the at least one membrane 108. In some embodiments, chip 110 and membrane 108 may not be electronically coupled. In this way, a controller associated with main unit 600 may read data from chip 110 and cause an actuation of membrane 108 by providing a corresponding signal to the membrane. The corresponding signal, as defined by parameters read from chip 110, may be provided from main unit 600 to cartridge 100 via the contact point. In other embodiments, the signal may be provided to membrane 108 via actuation means embedded within cartridge 100 itself. In said embodiments, a controller in the main unit 600 may be used to trigger or activate the actuation based on settings received by the main unit 600 (e.g., a user definition).

Further, the main unit 600 may be directly used to dispense fluid from one or more cartridges in the multiple cartridges 602A-D. The one or more cartridges may be selected by the user. The main unit 600 may include a user selectable interface that allows the user to select one or more cartridges. The main unit 600 may also include a controller in order to enable a user to dispense fluid based on the one or more cartridges selected by the user. Further, the main unit 600 may allow the user to dispense fluids from multiple cartridges simultaneously.

As will be detailed below, main unit 600 may be connected to a power source and comprise a computing device configured to be operable with and send operating instructions or electrical signals to the electronic components of cartridge 100. For example, main unit 600 may receive, via remote or local instructions, certain requirements for the dispensing of certain fluids. The instructions may be received from a user, either locally or remotely residing, upon main unit 600's provision of a plurality of options for user selection. Said options may be derived from main unit 600 reading of which cartridges are available for dispensing, based on, for example, cartridge status and cartridge marker ID provided by, by way of non-limiting example, a chip and a memory storage that may be associated with each cartridge. As will be detailed below, upon receipt of the selection, main unit 600 may be configured to provide at least one set of instructions, or at least one electric signal, to actuate a dispensing mechanism corresponding to the cartridge or cartridges associated with the user's selection.

III. Cartridge Operation

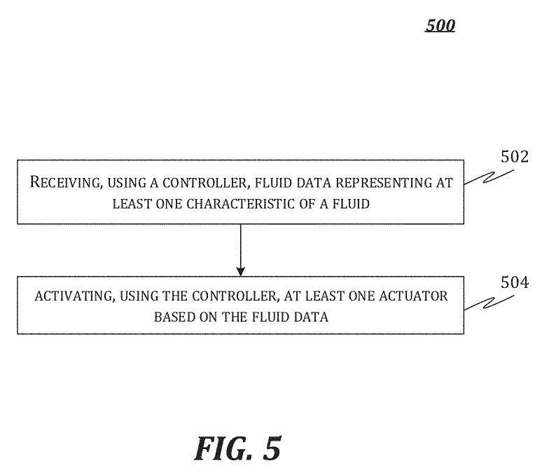

FIG. 5 illustrates a flowchart of a method 500 of dispensing fluid using the cartridge, in accordance with some embodiments. The cartridge may include a container configured to store the fluid. The method 500 may include a step 502 of receiving, using a controller, fluid data representing at least one characteristic of a fluid. The fluid data may be received from a storage device configured to store the fluid data. Further, the method 500 may include a step 504 of activating, using the processor, at least one actuator based on the fluid data. The actuation may be in response to instructions or electrical signal transmission. The instructions and/or electrical signal may be received from a locally configured main unit and/or remotely operated main unit.

The at least one actuator, upon activation, may be configured to cause the fluid to pass through the at least one membrane. As a result, the method 500 may facilitate accurate dispensing of the fluid based on the at least one characteristic of the fluid. As specified above, the actuator may be comprised of multiple components, for example, but not limited to, a controller, an amplifier, and a power source. The actuator may be embedded within a main unit or within the cartridge itself.

In some other embodiments, the method may further include a step of sensing the at least one characteristic of the fluid based on one or more sensors. For example, the one or more sensors may be configured to determine at least one of a viscosity, density, temperature, pressure, specific volume, specific weight and specific gravity. As a result, the method may enable automatic and adaptive dispensing of the fluid based on specific characteristics of the fluid.

Further, in some embodiments, a container configured to store a fluid may include an embedded marker that conveys an ID of the fluid and/or the at least one characteristic of the fluid. Accordingly, the cap may include a sensor configured to detect the embedded marker. For example, the embedded marker may include an etching on a glass container, while the sensor may be an optical sensor configured to detect the etching and extract the ID and/or the at least one characteristic. As a result, a single cap may be used with different containers containing different kinds of fluids, while adaptively controlling the dispensing based on respective characteristics of the fluids.

It should be understood that, in some embodiments, different operations of method 500 may be performed by different networked elements in operative communication with a computing device. For example, a remotely located computing device 700 may be employed in the performance of some or all of the stages in method 500. Moreover, a remote operation of the controllers described herein is also possible via telecommunications or other wireless network implementations. Further still, certain stages may be performed by main unit 600, while other stages may be performed by cartridge 100. While in some embodiments, cartridge 100 may be configured to perform all the stages of method 500.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Architecture to implement the stages of method 500 will be described in greater detail below.

IV. Controller Architecture

One or both of the cartridge 100 and the main unit 600 may be comprise a system having a memory storage and a processing unit, such as, for example, but not limited to, all or some of the components illustrated in FIG. 7 and detailed below. The processing unit coupled to the memory storage, wherein the processing unit is configured to perform the stages of method 500.

FIG. 7 is a block diagram of a system including computing device 700 that may be used to implement at least one of the controller of the cartridge 100, in embodiments where cartridge 100 may comprise a controller coupled/operatively associated with chip 110, and/or the controller of the main unit 600. Consistent with an embodiment of the disclosure, the aforementioned memory storage, and processing unit may be implemented in a computing device, such as computing device 700 of FIG. 7. Any suitable combination of hardware, software, or firmware may be used to implement the memory storage and processing unit. For example, the memory storage and processing unit may be implemented with computing device 700 or any of other computing devices 718, in combination with computing device 700. The aforementioned system, device, and processors are examples and other systems, devices, and processors may comprise the aforementioned memory storage and processing unit, consistent with embodiments of the disclosure.

With reference to FIG. 7, a system consistent with an embodiment of the disclosure may include a computing device or cloud service, such as computing device 700. In a basic configuration, computing device 700 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling computing device 700's operation. In one embodiment, programming modules 706 may include a cartridge identifier module, a fluid parameter module and a fluid dispensing module. Furthermore, embodiments of the disclosure may be practiced in conjunction with a graphics library, other operating systems, or any other application program and is not limited to any particular application or system. This basic configuration is illustrated in FIG. 7 by those components within a dashed line 708.

Computing device 700 may have additional features or functionality. Such additional storage is illustrated in FIG. 7 by a removable storage 709 and a non-removable storage 710. Computer storage media may include volatile and nonvolatile, removable and non-removable media implemented in any method or technology for storage of information, such as computer readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, or any other medium which can be used to store information and which can be accessed by computing device 700. Any such computer storage media may be part of device 700. Computing device 700 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 704, including operating system 705. While executing on processing unit 702, programming modules 706 (e.g., application 720) may perform processes including, for example, stages of method 500 as described above, as well as other methods disclosed herein. Application 720 may be configured for telecommunication operation for the remote control of, for example, main unit 600 and method 500. The aforementioned process is an example, and processing unit 702 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device. The computer-usable or computer-readable medium may be, for example, but not limited to, an electronic, magnetic, optical, electromagnetic, infrared, or semiconductor system, apparatus, device, or propagation medium.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1.

A cartridge for dispensing a fluid, the cartridge comprising:

a container configured to contain the fluid, wherein the container comprises at least one opening;

at least one membrane configured to be in fluid communication with the at least one opening, wherein the at least one membrane is permeable to the fluid;

at least one storage device configured to store fluid data representing at least one characteristic associated with the fluid; and

a contact point to a controller, wherein the cartridge is configured to be coupled to at least one controller via the contact point, wherein the at least one controller is configured to provide a signal to the at least one membrane based on the fluid data.

Aspect 2.

The cartridge of Aspect 1 wherein the at least one controller is in operative control of an electric power source configured to an amplifier, the at least one storage device and the at least one controller.

Aspect 3.

The cartridge of Aspect 1, wherein the fluid is characterized by at least one of a liquid state and a gaseous state.

Aspect 4.

The cartridge of Aspect 1, wherein the fluid comprises a liquid.

Aspect 5.

The cartridge of Aspect 4, wherein the fluid comprises an essential oil.

Aspect 6.

The cartridge of Aspect 1 further comprising a cap configured to be attachable to the container, wherein the cap comprises a first opening, a second opening and a channel configured to provide a fluid communication between the first opening and the second opening, wherein the first opening is fluidly coupled to the at least one opening of the container, wherein the second opening is covered by the at least one membrane, wherein each of the at least one actuator, the at least one storage device and the at least one controller are comprised in the cap.

Aspect 7.

The cartridge of Aspect 6, wherein the cap comprises a blocking ring configured to cause the cap to be irremovably attached to the container.

Aspect 8.

The cartridge of Aspect 6, wherein the cap is configured to attach to a DIN18 bottle head.

Aspect 9.

The cartridge of Aspect 1, wherein the fluid is transported from the container to a vicinity of the at least one membrane without using an actuated transport mechanism.

Aspect 10.

The cartridge of Aspect 1, wherein the fluid is transported from the container to a vicinity of the at least one membrane without using a tube.

Aspect 11.

The cartridge of Aspect 1, wherein the fluid is transported from the container to a vicinity of the at least one membrane through action of gravity.

Aspect 12.

The cartridge of Aspect 11, wherein the cartridge is configured to be in one of an upright orientation and an inverted orientation, wherein in the upright orientation, the fluid in the container is not in contact with the at least one membrane, wherein in the inverted orientation, the fluid flows from the container towards the at least one membrane causing the fluid to be in contact with the at least one membrane to facilitate dispensing of the fluid through the at least one membrane.

Aspect 13.

The cartridge of Aspect 12 further comprising a cap configured to be attachable to the container, wherein the cap comprises a first opening, a second opening and a channel configured to provide a fluid communication between the first opening and the second opening, wherein the first opening is fluidly coupled to the at least one opening of the container, wherein an upper portion of the channel is configured to facilitate stable resting of the cartridge on a horizontal surface in the inverted orientation.

Aspect 14.

The cartridge of Aspect 13, wherein the upper portion is substantially flat.

Aspect 15.

The cartridge of Aspect 1, wherein the at least one membrane comprises a piezoelectric membrane.

Aspect 16.

The cartridge of Aspect 1, wherein the at least one membrane comprises a plurality of micropores, wherein the at least one actuator is configured to create a pressure differential between an inside of the at least one membrane and an outside of the at least one membrane, wherein the pressure differential causes ejection of the fluid through the at least one membrane facilitating dispensing of the fluid from the cartridge.

Aspect 17.

The cartridge of Aspect 1, wherein the at least one membrane comprises a plurality of micropores configured to alternate between a closed state and an open state.

Aspect 18.

The cartridge of Aspect 1, wherein the at least one membrane comprises a plurality of micropores, wherein the at least one actuator is configured to alter a size of a micropore.

Aspect 19.

The cartridge of Aspect 1, wherein the signal causes an alteration in a size of a micropore based on the at least one characteristic of the fluid, wherein the storage device is configured to store an association between the at least one characteristic and the size of the micropore.

Aspect 20.

The cartridge of Aspect 1, wherein the at least one membrane comprises a plurality of micropores, wherein a size of a micropore is based on at least one characteristic of the fluid.

Aspect 21.

The cartridge of Aspect 1, wherein the signal causes an alteration in a flow of the fluid through the at least one membrane.

Aspect 22.

The cartridge of Aspect 1, wherein the signal causes air to flow in through the at least one membrane and into the at least one opening of the container, wherein the at least one actuator is further configured to cause the fluid to flow out through the at least one membrane.

Aspect 23.

The cartridge of Aspect 22, wherein the signal is configured to generate vibrations in the at least one membrane to cause flow of the fluid through the at least one membrane.

Aspect 24.

The cartridge of Aspect 23, wherein the signal is configured to generate the vibrations based on alternative current.

Aspect 25.

The cartridge of Aspect 1, wherein the at least one membrane is treated to exhibit anti-wetting properties in relation to the fluid.

Aspect 26.

The cartridge of Aspect 25, wherein the anti-wetting properties is configured to prevent leakage of the fluid through the at least one membrane in an absence of activation of the at least one actuator.

Aspect 27.

The cartridge of Aspect 25, wherein the anti-wetting properties is configured to ensure sufficient flow of air through the at least one membrane and into the at least one opening upon activation of the at least one actuator.

Aspect 28.

The cartridge of Aspect 1, wherein the at least a portion of the at least one membrane exhibits oleophobic properties.

Aspect 29.

The cartridge of Aspect 1, wherein the at least a portion of the at least one membrane exhibits hydrophobic properties.

Aspect 30.

The cartridge of Aspect 1, wherein the storage device is further configured to store an identifier (ID) associated with the cartridge.

Aspect 31.

A cap configured for use with a container of fluid, the cap comprising:
a first opening configured to be coupled with a mouth of a container;
a second opening configured to facilitate dispensing of the fluid;
a channel configured to fluidly connect the first opening to the second opening;
a membrane covering the second opening, wherein the membrane is permeable to the fluid; and
a storage device configured to store fluid data representing at least one characteristic associated with the fluid,
wherein the cap is electrically coupled to a controller, an amplifier, and the storage device, without bridging the amplifier to the storage device, wherein the controller is configured to provide an activation signal to the amplifier based on the fluid data retrieved from the storage device.

Aspect 32.

The cap of Aspect 31, wherein the membrane comprises at least one of an olephobic substance and a hydrophobic substance on at least one side of the membrane.

Aspect 33.

The cap of Aspect 31, wherein the first opening comprises a threaded cavity configured to mechanically engage with a threaded exterior around the mouth of the container.

Aspect 34.

The cap of Aspect 33 further comprising a blocking ring configured to prevent the cap from being removed once screwed onto the container.

Aspect 35.

The cap of Aspect 33 configured for use with, but not limited to, a DIN18 bottle head.

Aspect 36.

The cap of Aspect 31, wherein the membrane comprises a piezoelectric membrane, wherein the cap further comprises an electrical power source configured to provide electrical power to each of the piezoelectric membrane, the storage device, and the controller.

Aspect 37.

The cap of Aspect 31, wherein the channel is shaped in the form of a bend, wherein an exterior portion of the bend is substantially flat in order to facilitate stable resting of the cap on a horizontal surface.

Aspect 38.

A system for dispensing a fluid, the system comprising:

A cartridge comprising:

a container configured to contain the fluid, wherein the container comprises at least one opening;

at least one membrane configured to be in fluid communication with the at least one opening, wherein the at least one membrane is permeable to the fluid;

at least one actuator coupled to the at least one membrane, wherein the at least one actuator, upon activation, is configured to cause the fluid to pass through the at least one membrane;

at least one storage device configured to store fluid data representing at least one characteristic associated with the fluid; and

A main unit comprising:

at least one controller, wherein the at least one controller is configured to control activation of the at least one actuator based on the fluid data.

Aspect 39.

A cartridge comprising:

a container configured to contain the fluid, wherein the container comprises at least one opening;

at least one membrane configured to be in fluid communication with the at least one opening, wherein the at least one membrane is permeable to the fluid;

at least one actuator coupled to the at least one membrane, wherein the at least one actuator, upon activation, is configured to cause the fluid to pass through the at least one membrane;

at least one storage device configured to store fluid data representing at least one characteristic associated with the fluid; and

at least one controller, wherein the at least one controller is configured to control activation of the at least one actuator based on the fluid data.

Aspect 40.

A method 500.

Aspect 41.

A system configured to enable method 500.

Aspect 42.

A cartridge as disclosed in the specification.

Aspect 43.

A system comprising a cartridge and a main unit for operating the cartridge.

1. A cartridge for dispensing a fluid, the cartridge comprising:
a container configured to contain the fluid, wherein the container comprises at least one opening;
at least one membrane configured to be in fluid communication with the at least one opening, wherein the at least one membrane is permeable to the fluid;
at least one storage device configured to store fluid data representing at least one characteristic associated with the fluid; and
a contact point to a controller, wherein the cartridge is configured to be coupled to at least one controller via the contact point, wherein the at least one controller is configured to provide a signal to the at least one membrane based on the fluid data.

2. The cartridge of claim 1 wherein the at least one controller is in operative control of an electric power source configured to an amplifier, the at least one storage device and the at least one controller.

3. The cartridge of claim 1, wherein the fluid is characterized by at least one of a liquid state and a gaseous state.

4. The cartridge of claim 1, wherein the fluid comprises a liquid.

5. The cartridge of claim 4, wherein the fluid comprises an essential oil.

6. The cartridge of claim 1 further comprising a cap configured to be attachable to the container, wherein the cap comprises a first opening, a second opening and a channel configured to provide a fluid communication between the first opening and the second opening, wherein the first opening is fluidly coupled to the at least one opening of the container, wherein the second opening is covered by the at least one membrane, wherein each of the at least one actuator, the at least one storage device and the at least one controller are comprised in the cap.

7. The cartridge of claim 6, wherein the cap comprises a blocking ring configured to cause the cap to be irremovably attached to the container.

8. The cartridge of claim 6, wherein the cap is configured to attach to a DIN18 bottle head.

9. The cartridge of claim 1, wherein the fluid is transported from the container to a vicinity of the at least one membrane without using an actuated transport mechanism.

10. The cartridge of claim 1, wherein the fluid is transported from the container to a vicinity of the at least one membrane without using a tube.

11. The cartridge of claim 1, wherein the fluid is transported from the container to a vicinity of the at least one membrane through action of gravity.

12. The cartridge of claim 11, wherein the cartridge is configured to be in one of an upright orientation and an inverted orientation, wherein in the upright orientation, the fluid in the container is not in contact with the at least one membrane, wherein in the inverted orientation, the fluid flows from the container towards the at least one membrane causing the fluid to be in contact with the at least one membrane to facilitate dispensing of the fluid through the at least one membrane.

13. The cartridge of claim 12 further comprising a cap configured to be attachable to the container, wherein the cap comprises a first opening, a second opening and a channel configured to provide a fluid communication between the first opening and the second opening, wherein the first opening is fluidly coupled to the at least one opening of the container, wherein an upper portion of the channel is configured to facilitate stable resting of the cartridge on a horizontal surface in the inverted orientation.

14. The cartridge of claim 13, wherein the upper portion is substantially flat.

15. The cartridge of claim 1, wherein the at least one membrane comprises a piezoelectric membrane.

16. The cartridge of claim 1, wherein the at least one membrane comprises a plurality of micropores, wherein the at least one actuator is configured to create a pressure differential between an inside of the at least one membrane and an outside of the at least one membrane, wherein the pressure differential causes ejection of the fluid through the at least one membrane facilitating dispensing of the fluid from the cartridge.

17. The cartridge of claim 1 further comprising:
at least one actuator coupled to the at least one membrane, wherein the at least one actuator, upon activation, is configured to cause the fluid to pass through the at least one membrane; and
at least one controller, wherein the at least one controller is configured to control activation of the at least one actuator based on the fluid data.

18. A system for dispensing a fluid, the system comprising:
A cartridge comprising:
a container configured to contain the fluid, wherein the container comprises at least one opening;
at least one membrane configured to be in fluid communication with the at least one opening, wherein the at least one membrane is permeable to the fluid;
at least one actuator coupled to the at least one membrane, wherein the at least one actuator, upon activation, is configured to cause the fluid to pass through the at least one membrane;
at least one storage device configured to store fluid data representing at least one characteristic associated with the fluid; and
A main unit comprising:
at least one controller, wherein the at least one controller is configured to control activation of the at least one actuator based on the fluid data.

19. The system of claim 18 further comprising: a cap configured for use with a container of fluid, the cap comprising:
a first opening configured to be coupled with a mouth of a container;
a second opening configured to facilitate dispensing of the fluid;
a channel configured to fluidly connect the first opening to the second opening;
a membrane covering the second opening, wherein the membrane is permeable to the fluid; and
a storage device configured to store fluid data representing at least one characteristic associated with the fluid,
wherein the cap is electrically coupled to a controller, an amplifier, and the storage device, without bridging the amplifier to the storage device, wherein the controller is configured to provide an activation signal to the amplifier based on the fluid data retrieved from the storage device.

20. A method, comprising:
receiving, using a controller, fluid data representing at least one characteristic of a fluid, and
activating, using the controller, at least one actuator based on the fluid data.
